(19) United States
(12) Patent Application Publication
(10) Pub. No.: US 2017/0198494 A1
(43) Pub. Date: Jul. 13, 2017

(54) COMPLEX LOCK ASSEMBLY STRUCTURE

(71) Applicant: Taiwan Puritic Corp., Hsinchu County (TW)

(72) Inventor: Yamei CHANG, Hsinchu County (TW)

(21) Appl. No.: 15/048,087

(22) Filed: Feb. 19, 2016

(30) Foreign Application Priority Data
Jan. 11, 2016 (TW) 105200329

(51) Int. Cl. E05B 15/00; E05B 5/00

(52) U.S. Cl. CPC E05B 15/00; E05B 5/00

(57) ABSTRACT

A complex lock assembly structure comprises a body, a pressure-cylinder actuator, a door fastener and a mechanical lock. The front of the body has a frame. The pressure-cylinder actuator and the door fastener are disposed on and exposed from the back of the frame. The pressure-cylinder actuator and the door fastener actuate each other. The mechanical lock is disposed inside the frame on the front of the body and used to control and limit the movement of the door fastener.

### BACKGROUND OF THE INVENTION

1. Field of the Invention

The present invention relates to a lock assembly structure, particularly to a complex lock assembly structure having a dual unlocking mechanism, applicable to a valve chamber, a gas cylinder cabinet or a large door, and convenient for maintenance.

2. Description of the Prior Art

With fast advance of science and technology, electronic lock devices have been widely accepted and extensively used. Nowadays, many lock devices involve electronic elements, such as motor actuators, sensors and controllers. However, the lock devices using motor actuators are likely to generate sparks and may cause fire or gas explosion while they are applied to valve chambers administering special gases (such as combustible gases, inflammable gases and combustion assistant gases) or exposed to an environment having these special gases.

Thus are generated the lock devices using pneumatic actuators or hydraulic actuators to replace motor actuators. For a conventional lock device using a pneumatic or hydraulic actuator, the pneumatic or hydraulic actuator is normally encapsulated inside the lock device. Once the pneumatic or hydraulic actuator malfunctions, the actuator cannot be repaired unless the entire lock device is dismounted and dismantled. Besides, while an electronic lock device malfunctions, the lock device would entirely fail to work and make the door unlikely to open or lock. In such a case, the electronic lock device must be dismounted and disassembled instantly. Dismounting or disassembling the electronic lock device is likely to generate sparks and also likely to cause leakage of gases if the electronic lock device is applied to a special environment, such as a gas cylinder cabinet. Therefore, dismounting or disassembling an electronic lock device applied to an environment having special gases has a high risk in industrial safety.

Accordingly, the present invention proposes a novel complex lock assembly structure to overcome the important problem.

### SUMMARY OF THE INVENTION

One objective of the present invention is to provide a complex lock assembly structure enabling the user to maintain it easily and unlock it by hands and by the pressure-cylinder actuator.

To achieve the abovementioned objective, the present invention proposes a complex lock assembly structure, which comprises a body whose front has a frame; a pressure-cylinder actuator disposed on and exposed from a back of the body; a door fastener disposed on and exposed from the back of the body, having an interlocking relationship with the pressure-cylinder actuator; and a mechanical lock disposed inside the frame on the front of the body, controlling and limiting movement of the door fastener.

In one embodiment, the mechanical lock includes a lock head; a blocking plate whose locking function can be enabled or disabled by a key inserted into the lock head; a first elastic element disposed in the bottom of the frame; and a door handle, wherein the door handle and the first elastic element actuate each other, and wherein the first elastic element is used to restore the door handle to a preset position, and wherein the blocking plate is used to limit movement of the door handle, and wherein while the locking function of the blocking plate is disabled, opening the door handle actuates the action of the door fastener.

In one embodiment, at least one opening is formed in the bottom of the frame to facilitate movement of the door handle and the door fastener.

In one embodiment, the pressure-cylinder actuator is a pneumatic actuator or a hydraulic actuator.

In one embodiment, the pressure-cylinder actuator includes an interlocking assembly coupled to the door fastener for interlocking operations.

In one embodiment, the door fastener includes a latch and a latch connection element, which are connected by at least one screw assembly or fabricated into a one-piece component.

In one embodiment, the interlocking assembly is connected with the latch connection element by at least one screw assembly.

In one embodiment, the door handle includes a door handle connection element used to install the door handle in the body.

Below, embodiments are described in detail in cooperation with attached drawings to make easily understood the objectives, technical contents, characteristics and accomplishments of the present invention.

### BRIEF DESCRIPTION OF THE DRAWINGS

FIG. 1 is a front view schematically showing a complex lock assembly structure according to one embodiment of the present invention;

FIG. 2 is a rear view schematically showing a complex lock assembly structure according to one embodiment of the present invention;

FIG. 3 is a front view schematically showing a portion of a complex lock assembly structure according to one embodiment of the present invention;

FIG. 4 is an exploded view schematically showing a complex lock assembly structure according to one embodiment of the present invention;

FIG. 5A and FIG. 5B are diagrams schematically showing the operation of a complex lock assembly structure according to one embodiment of the present invention.

### DESCRIPTION OF THE PREFERRED EMBODIMENTS

The present invention provides a complex lock assembly structure, which has a novel structural design to achieve a dual control mechanism and safe maintenance.

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

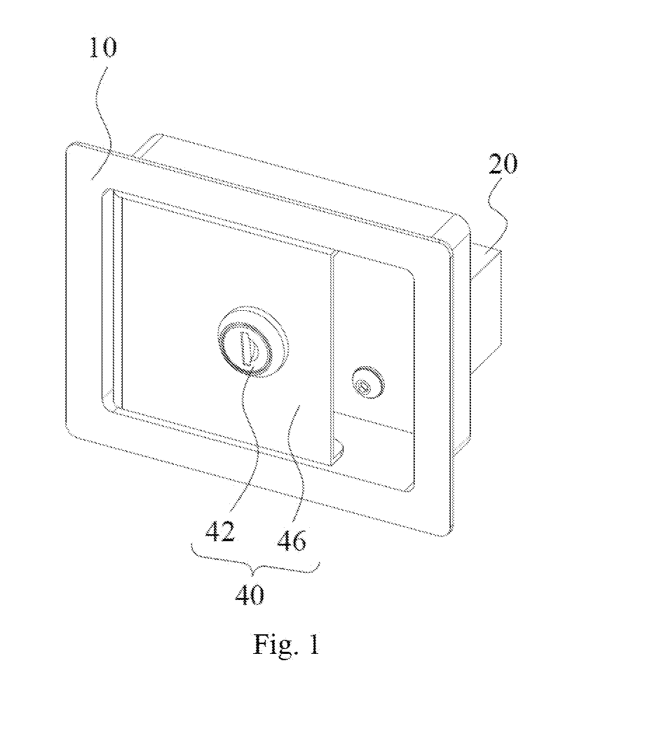

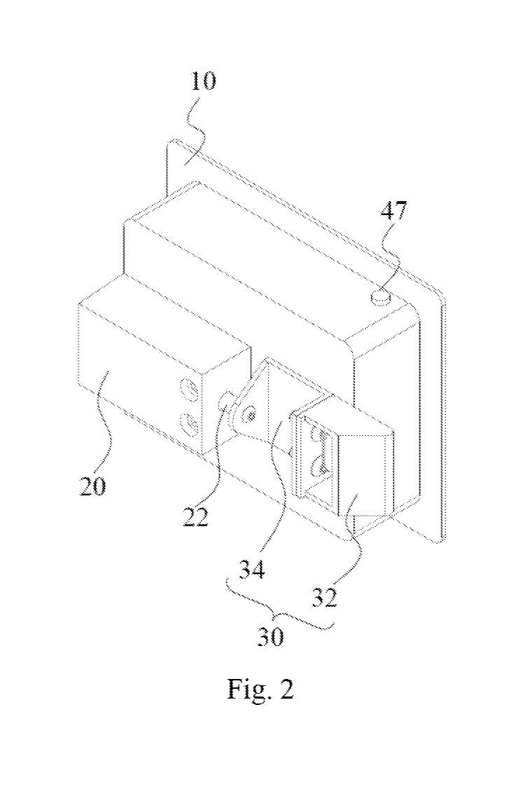

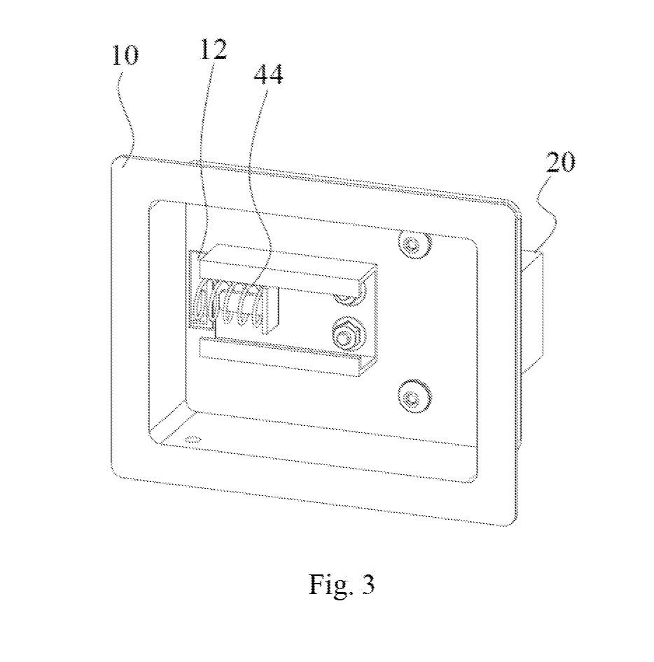

Refer to FIGS. 1-3. FIG. 1 is a front view schematically showing a complex lock assembly structure according to one embodiment of the present invention. FIG. 2 is a rear view schematically showing a complex lock assembly structure according to one embodiment of the present invention. FIG. 3 is a front view schematically showing a portion of a complex lock assembly structure according to one embodiment of the present invention. The complex lock assembly structure of the present invention comprises a body 10, a pressure-cylinder actuator 20, a door fastener 30 and a mechanical lock 40, which are to be described in detail below.

As shown in FIGS. 1-3, the front of the body 10 has a frame. The mechanical lock 40 is disposed inside the frame on the front of the body 10.

As shown in FIG. 1 and FIG. 2, the pressure-cylinder actuator 20 and the door fastener 30 are disposed on and exposed from the back of the body 10. The pressure-cylinder actuator 20 and the door fastener 30 has an interlocking relationship. The mechanical lock 40 disposed inside the frame on the front of the body 10 is used to limit and control the movement of the door fastener 30.

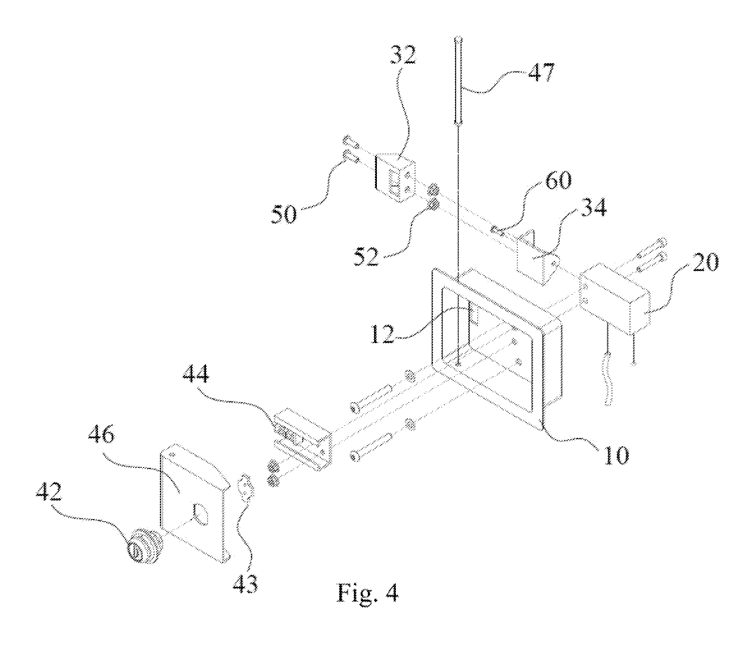

Refer to FIG. 1, FIG. 2 and FIG. 4. In one embodiment, the mechanical lock 40 includes a lock head 42, a blocking plate 43, a first elastic element 44 and a door handle 46. A key (not shown in the drawings) is used to operate the lock head 42 to enable or disable the blocking function of the blocking plate 43. The first elastic element 44 is disposed in the bottom of the frame of the body 10. The door handle 46 and the first elastic element 44 can actuate each other. If the user does not pull the door handle 46, the door handle 46 is restored to a preset position by the first elastic element 44. The blocking plate 43 is used to limit the movement of the door handle 46. While the key is inserted into the lock head 42 to disable the blocking function of the blocking plate 43, the door handle 46 can be operated to actuate the door fastener 30 and unlock the door.

Refer to FIG. 3. In one embodiment, at least one opening 12 is formed in the bottom of the frame of the body 10, allowing the movement of the door handle 46 and the door fastener 30. In one embodiment, the door handle 46 has a coupling element 47 for installing the door handle 46 in the body 10. The coupling element 47 can function as the pivotal axis to facilitate opening and closing of the door handle 46.

Refer to FIG. 2. The pressure-cylinder actuator 20 is a pneumatic actuator or a hydraulic actuator, such as a pneumatic cylinder or a hydraulic cylinder. In one embodiment, the pressure-cylinder actuator 20 includes an interlocking assembly 22, which is linked with the door fastener 30 for an interlocking operation. In one embodiment, the complex lock assembly structure further comprises a second elastic element (not shown in the drawings). The second elastic element is disposed between the pressure-cylinder actuator 20 and the door fastener 30. For example, the second elastic element sleeves the interlocking assembly 22, which is coupled to the pressure-cylinder actuator 20 and the door fastener 30. In such a design, while the pressure-cylinder actuator 20 fails, the second elastic element can push the door fastener 30 to a locking position. Thus, the door fastener 30 can still function to lock the door in such a case.

In one embodiment, the door fastener 30 includes a latch 32 and a latch connection element 34. The latch 32 and the latch connection element 34 are connected by at least one screw assembly, such as screws 50 and nuts 52, as shown in FIG. 4. It is easily understood: the door fastener 30 may be formed by a group of elements or fabricated into a one-piece component. In one embodiment, the interlocking assembly 22 is connected with the latch connection element 34, as shown in FIG. 2. In one embodiment, the interlocking assembly 22 and the latch connection element 34 are connected by at least one screw assembly, such as a screw 60, as shown in FIG. 4. In one embodiment, the interlocking assembly 22 has a threaded structure, and the screw 60 is screwed through the threaded structure to connect the interlocking assembly 22 and the latch connection element 34.

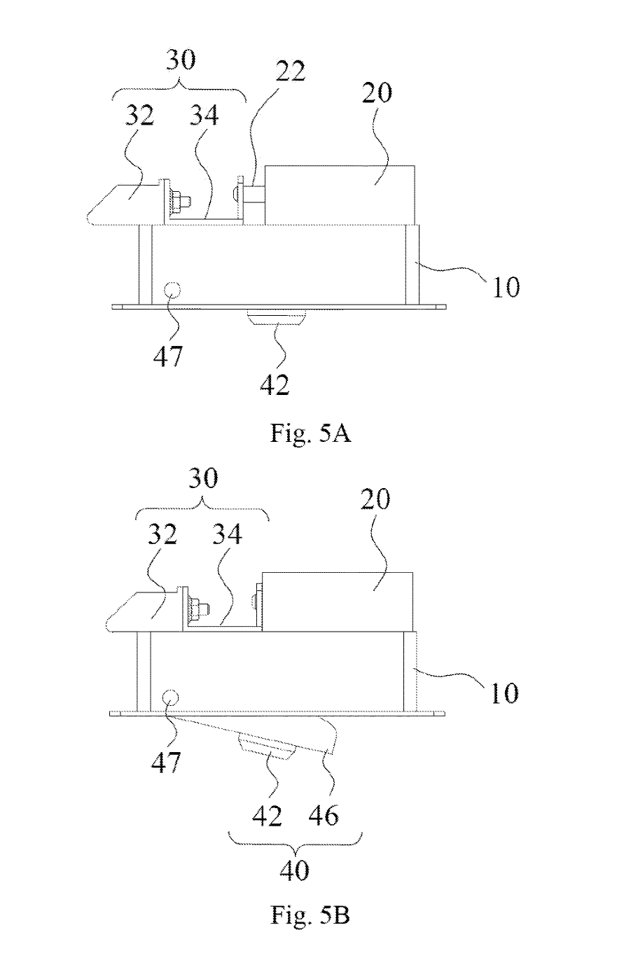

Refer to FIG. 5A and FIG. 5B diagrams schematically showing the operation of a complex lock assembly structure according to one embodiment of the present invention. As shown in FIG. 5A, in one embodiment, the pressure-cylinder actuator 20 actuates the door fastener 30 to move and protrude, whereby the door is locked. In the condition that the pressure-cylinder actuator 20 functions normally, the pressure-cylinder actuator 20 can control the door fastener 30 to draw back, whereby the door is unlocked. It is easily understood: while the pressure-cylinder actuator 20 functions normally, the mechanical lock 40 can be locked through the lock head 42 lest someone unlock the mechanical lock 40 manually. Refer to FIG. 5B. While the complex lock structure is in a locked state and while the pressure-cylinder actuator 20 fails or the power is interrupted, the mechanical lock 40 of the present invention will play a critical role. In such a case, a key is inserted into the lock head 42 to disable the blocking function of the blocking plate 43; then the user opens or pulls the door handle 46 to actuate the door fastener 30 and unlock the door.

The complex lock assembly structure of the present invention is characterized in integrating a pressure-cylinder lock and a mechanical lock and arranging the pressure-cylinder actuator and the mechanical lock respectively in the exterior and interior of the lock assembly structure to acquire the advantages of both. While power is interrupted or the pressure-cylinder actuator fails, the complex lock assembly structure can still use the mechanical lock to maintain the functions of locking and unlocking the door without being dismantled or repaired instantly. Thus is exempted from the danger caused by the failure of the lock. Therefore, the complex lock assembly structure only needs disassembling and maintaining on the scheduled dates. Besides, as the pressure-cylinder actuator is disposed on the exterior of the lock assembly structure, it is easy to replace and convenient to repair. Thus, the overall values of the present invention are to effectively increase the safety of usage and maintain the continuous operation of equipment.

In summary, the present invention provides a complex lock assembly structure enabling the user to maintain it easily and unlock it by hands and by the pressure-cylinder actuator.

What is claimed is:

1. A complex lock assembly structure comprising
a body whose front has a frame;
a pressure-cylinder actuator disposed on and exposed from a back of said body;
a door fastener disposed on and exposed from said back of said body, having an interlocking relationship with said pressure-cylinder actuator; and
a mechanical lock accommodated inside said frame on said front of said body, controlling and limiting movement of said door fastener.

2. The complex lock assembly structure according to claim 1, wherein said mechanical lock includes
a lock head;
a blocking plate whose locking function can be enabled or disabled by a key inserted into said lock head;
a first elastic element disposed in a bottom of said frame; and
a door handle, wherein said door handle and said first elastic element actuate each other, and wherein said first elastic element is used to restore said door handle to a preset position, and wherein said blocking plate is used to limit movement of said door handle, and wherein while said locking function of said blocking plate is disabled, opening said door handle actuates action of said door fastener.

3. The complex lock assembly structure according to claim 2, wherein at least one opening is formed in said bottom of said frame of said body to facilitate movement of said door handle and said door fastener.

4. The complex lock assembly structure according to claim 1, wherein said pressure-cylinder actuator is a pneumatic actuator or a hydraulic actuator.

5. The complex lock assembly structure according to claim 1, wherein said pressure-cylinder actuator includes an interlocking assembly coupled to said door fastener for interlocked operations.

6. The complex lock assembly structure according to claim 5, wherein said door fastener includes a latch and a latch connection element.

7. The complex lock assembly structure according to claim 6, wherein said latch and said latch connection element are connected by at least one screw assembly or fabricated into a one-piece component.

8. The complex lock assembly structure according to claim 6, wherein said interlocking assembly is connected with said latch connection element.

9. The complex lock assembly structure according to claim 8, wherein said interlocking assembly is connected with said latch connection element by at least one screw assembly.

10. The complex lock assembly structure according to claim 1, wherein said door handle includes a door handle connection element used to install said door handle in said body.

11. The complex lock assembly structure according to claim 1 further comprising a second elastic element disposed between said pressure-cylinder actuator and said door fastener and used to push said door fastener to a locking position.
